(19) United States
(12) Patent Application Publication
(10) Pub. No.: US 2026/0178554 A1
(43) Pub. Date: Jun. 25, 2026

(54) STORING POPULARITY METADATA FOR EMBEDDING VECTORS

(71) Applicant: ADVANCED MICRO DEVICES, INC., Santa Clara, CA (US)

(72) Inventors: Vignesh Adhinarayanan, Austin, TX (US); Rishabh Jain, State College, PA (US)

(21) Appl. No.: 18/988,848

(22) Filed: Dec. 19, 2024

(51) Int. Cl. G06F 16/22

(52) U.S. Cl. CPC G06F 16/2237

(57) ABSTRACT

One or more processors are configured to modify information representing popularities of entries stored in a first table in response to access requests to the entries. The popularities represent frequencies or likelihoods that corresponding ones of the entries were previously accessed. The processor is also configured to select a subset of the entries based on their popularities and copy the subset of the entries from the first table to a second table. In some cases, the entries in the first table stored vector embedding generated by a recommendation model. A filter, such as a Bloom filter, can be configured to selectively route data requests to the first table or the second table.

### BACKGROUND

Artificial intelligence (AI) or machine learning (ML) models operate on numerical representations of data such as text, audio, and images. A typical numerical representation is an embedding such as a vector embedding that encodes features of the data in a series (or vector) of numerical values. Embedding vectors are used to transform a high-dimensional data into a lower-dimensional space, preserving some aspects of the structure of the original data. For example, a model can be trained to output vector representations of data points that correspond meaningfully to real-world features of the data points. A vector embedding should be chosen so that similarities between real-world data points are captured in correspondingly similar vector embeddings. Features or qualities shared by two data points should be reflected in both of their vector embeddings. Dissimilar data points should have dissimilar vector embeddings. Meta's Deep Learning Recommendation Model (DLRM) is a popular and commercially relevant example of an AI/ML model that embeds high-dimensional vectors into a lower-dimensional space in the form of embedding tables. A typical embedding table is implemented in dynamic random-access memory (DRAM) using four million (4M) or more rows that each hold a predetermined number (e.g., four) DRAM atoms. An atom is the smallest amount of data that can be transferred to or from the DRAM.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 illustrates a processing system configured to associate popularity metadata with embedding vectors, according to some embodiments.

FIG. 2 illustrates a system that selectively routes memory access requests to a primary table or a hot table based on the popularity of the requested entries, according to some embodiments.

FIG. 3 illustrates a method of managing a hot table that stores or caches copies of popular entries from a larger table, according to some embodiments.

FIG. 4 illustrates a method of selectively routing memory access requests to a table or a hot table that includes a subset of popular entries in the table, according to some embodiments.

FIG. 5 illustrates a processing system that is implemented with circuitry for multiple compute units, according to some embodiments.

### DETAILED DESCRIPTION

Recommendation models such as DLRM use random access to look up information in the embedding tables. Page tables translate virtual addresses of the entries in the embedding tables to physical addresses, and translation lookaside buffers (TLBs) cache frequently used address translations. In many applications, the TLBs speed up the address translation process for frequently accessed virtual addresses. However, the random-access pattern of the recommendation model significantly reduces or eliminates the benefits of TLBs associated with embedding tables. For example, recommendation models can perform embedding bags operations that read a small subset of entries (e.g., 80 rows of DRAM) in the embedding table and then collapse the entries to a single value. Since the recommendation model randomly accesses small subsets of entries in a large embedding table, the entries in the TLB are frequently replaced before the TLB receives requests for the address translations stored in the entries. For example, an entry to the TLB for a first virtual address is likely to be replaced by an entry for a second virtual address before the TLB receives the next request for a translation of the first virtual address. Consequently, most or substantially all requests from the recommendation model to the TLB are misses, and each TLB miss results in a time-consuming and resource-consuming table walk of the page table.

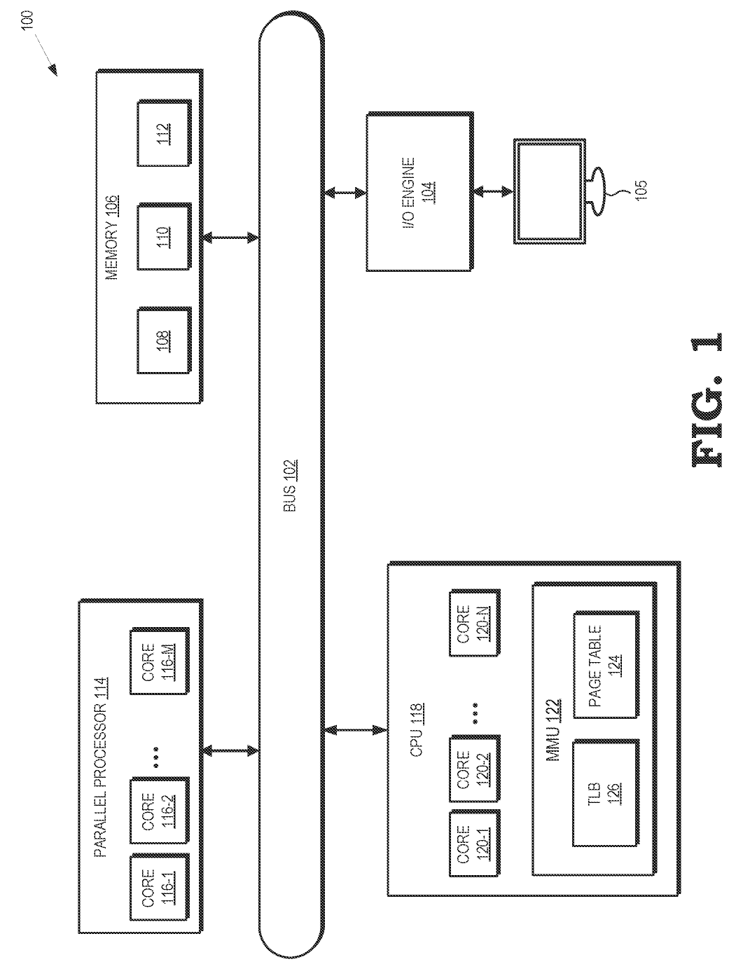

FIGS. 1-5 illustrate systems, apparatuses, and methods of reducing the number of page table walks, and the latency caused by TLB misses, by storing subsets of embedding table entries in different tables based on the entry’s popularity, e.g., the frequency or likelihood that the entry was previously accessed. One or more bits associated with each entry store information representing the popularity of the entry. In some embodiments, the information representing the popularity is stored in a subset of bits used to store metadata associated with the entry. For example, a 32-byte (B) atom in DRAM can be associated with 4B of metadata and 2B of the metadata are typically reserved for error correcting codes (ECC). The remaining 2B of metadata can then be overloaded with other information including the information representing the popularity of entries in the embedding table. In some embodiments, dimensions are added to the vectors in the entries of the embedding table and the additional bits of the vectors store the information representing the popularity of the entries.

The stored information representing the popularities the entries can be used to cache entries from the embedding table. In some embodiments, a subset of the embedding table entries is selected from the main (or first) embedding table based on the popularities of the entries in the subset. A second embedding table stores the selected subset of the first embedding table entries. The second table can be referred to as a “hot” table. A filter, such as a Bloom filter, is configured to selectively route data requests to the first or second embedding table. In response to receiving one or more indices, the filter determines whether each index is likely to be present in the second embedding table. If so, the filter routes the data request to the second embedding table. Otherwise, the filter routes the request to the first embedding table. The popularity of an entry is incremented in response to requests for the entry, e.g., by modifying the metadata bits that store the information representing the popularity. The second embedding table is updated to reflect the changes in the popularities of the entries. The second embedding table can be updated periodically, at predetermined time intervals, or in response to events. For example, the second embedding table can be updated after epochs lasting several hours to a few days.

Other functionality can also be implemented using the information representing the popularity of the entries. In some embodiments, a hierarchy of embedding tables includes multiple levels of embedding tables that store different subsets of embedding table entries based on their popularity. For example, the main (or first) embedding table sits at the top of the hierarchy and stores all the entries. One or more second embedding tables are configured to store entries having relatively high popularities and one or more third embedding table stored entries having the highest popularities. Additional levels of the hierarchy can be implemented in other embodiments. In some embodiments, the embedding table is partitioned such that threads (or wavefronts) running on different compute units are only responsible for updating values within specific partitions of the table. In that case, each compute unit is associated with one or more second embedding tables that store high popularity subsets of the embedding table entries from the partition associated with the compute unit.

The popularity information can also be used to perform operations at a higher level of granularity. In some embodiments, the information representing the popularity of the entries is used to prefetch address translations, perform load balancing between compute units, or allocate resources. For example, the processor cores of a CPU can be grouped into one or more clusters and a TLB can be shared by the processor cores within each cluster. The TLBs are not shared between the clusters and each TLB remains private to a cluster. In commercial implementations of DLRM, embedding bags operations are performed concurrently or in parallel over multiple embedding tables and threads are assigned to operate on selected embedding tables. If some threads access the hot table of an embedding table more often than other threads, the mapping of the threads to cores is modified so that the average distribution of accesses over the different tables remains consistent across the clusters. Thus, the load is balanced across compute units, processor cores, or clusters to average out the TLB pressure resulting from accesses to the hot table. Alternatively, private caches in the clusters, as well as the corresponding TLBs, can be allocated to hold entries only from the hot tables associated with the embedding table(s) associated with threads executing on cores in the cluster.

FIG. 1 illustrates a processing system 100 configured to associate popularity metadata with embedding vectors, according to some embodiments. The processing system 100 includes a bus 102 implemented with circuitry that supports communication between entities implemented in the processing system 100. Some implementations of the processing system 100 include other buses, bridges, switches, routers, and the like, which are not shown in FIG. 1 in the interest of clarity. An input/output (I/O) engine 104 is implemented with circuitry that handles input or output operations associated with display 105, as well as other elements of the processing system 100 such as keyboards, mice, printers, external disks, and the like. The I/O engine 104 is coupled to the bus 102 so that the I/O engine 104 can communicate with other entities in the processing system 100 by exchanging signals over the bus 102.

Processing system 100 also includes or has access to a memory 106 or other storage component implemented using a non-transitory computer-readable medium, for example, a dynamic random-access memory (DRAM). However, some embodiments of the memory 106 are implemented using other types of memory including, for example, static random-access memory (SRAM), nonvolatile RAM, and the like. Some embodiments of the memory 106 include an external memory implemented external to the processing units implemented in the processing system 100. The memory 106 can store information representing instructions such as program code 108 for one or more applications (e.g., graphics applications, compute applications, machine-learning applications), data 110 that is consumed by the program code 108, and results 112 produced by executing the program code 108.

Some embodiments of the processing system 100 include a parallel processor 114. The parallel processor 114 can include, for example, a GPU, a general-purpose GPU (GPGPU), a neural processing unit (NPU), an intelligence processing unit (IPU) or other vector processor or type of parallel processor. The parallel processor 114 includes circuitry to implement one or more processor cores 116-1..M that each operate as a compute unit configured to perform one or more operations based on one or more instructions received by the parallel processor 114. Although three processor cores 116 are shown in FIG. 1, more or fewer processor cores 116 can be implemented in other embodiments of the parallel processor 114. The compute units in the processor cores 116 are implemented as circuitry for one or more single-instruction, multiple data (SIMD) units that perform the same operation on different data sets to produce one or more results.

The processing system 100 includes a central processing unit (CPU) 118 that is connected to the bus 102 to communicate with other entities in the processing system 100, such as the I/O engine 104, the memory 106, or the parallel processor 114. The CPU 118 implements circuitry including a plurality of processor cores 120-1, 120-2, .. 120-N that execute instructions concurrently or in parallel. Although three processor cores 120 are shown in FIG. 1, more or fewer processor cores 120 can be implemented in other embodiments of the CPU 118. The processor cores 120 include circuitry to implement one or more compute units such as single-instruction, multiple data (SIMD) units that perform the same operation on different data sets to produce one or more results. The CPU 118 is configured to execute instructions such as the program code 108 for one or more applications (e.g., graphics applications, compute applications, machine-learning applications), which is stored in the memory 106. The CPU 118 can consume data 110 and store information in the memory 106 such as the results 112 of the executed instructions.

The CPU 118 includes a memory management unit (MMU) 122 that is implemented using circuitry configured to monitor memory references or memory access requests that are conveyed over the bus 102. The MMU 122 is responsible for translating virtual memory addresses in the memory access requests into physical addresses in a memory, such as the memory 106. Some embodiments of the MMU 122 support access to fixed-sized blocks known as pages or operating system (OS) pages. For example, in response to receiving a memory access request including a virtual memory address, the MMU 122 translates a subset of the most significant bits in the virtual memory address (known as the virtual page number) into a physical address of the page in the memory. The requested location in the page is indicated by the remaining subset of least significant bits in the virtual memory address. This subset of least significant bits is also referred to as the page offset. In the illustrated embodiment, virtual memory address translation is implemented using a page table 124 and a translation lookaside buffer (TLB) 126. The page table 124 includes entries that translate the allocated virtual page numbers to their corresponding physical addresses. The TLB 126 stores or caches frequently used translations of the allocated virtual page numbers to reduce the time required to translate the virtual memory address.

As discussed herein, the access patterns for some types of tables stored in the memory 106, such as randomly accessing an embedding table used by a recommendation model, significantly reduce or eliminate the benefits provided by the TLB 126 that is associated with the randomly accessed table. To address this problem, subsets of the entries in tables stored in the memory 106 are copied (or cached) into a second, smaller table that can be referred to as a “hot” table. The entries in the subsets are selected based on their popularities. As used herein, the term “popularity” refers to measures of the likelihood that an entry will be accessed in a subsequent memory access request. The popularity of an entry can be determined by a number of previous memory access requests, a frequency of memory access requests, patterns of previous memory access requests, or other statistical measures of the probability that the entry will be accessed. For example, the popularity of an entry can be increased or incremented in response to each memory access request during a time interval or epoch. In some embodiments, popularities can be determined using artificial intelligence/machine learning (AI/ML) models that are trained on sequences of memory access requests. At the end of the time interval or epoch, the hot table is flushed to remove the previously stored entries, the most popular entries in the table are copied into the hot table, and the popularities are reset before beginning the next epoch.

Some embodiments of the MMU 122 include a filter (not shown in FIG. 1 in the interest of clarity) that selectively routes data requests to the larger, primary table or the smaller, hot table. For example, a Bloom filter can receive indices in the data requests that indicate the virtual memory addresses of the requested entries from the primary table. The Bloom filter determines, based on the indices, whether a requested entry is possibly stored in the hot table or definitely not stored in the hot table. The Bloom filter routes the data request to the hot table in response to determining that the requested entry is possibly stored in the hot table. The Bloom filter routes the data request to the primary table in response to determining that the requested entry is definitely not stored in the hot table. The hot table is smaller than the primary table (e.g., the hot table can be stored on a single page or a few pages). Consequently, selectively storing popular entries in the hot table and then routing the corresponding memory access requests to the hot table concentrates the resulting address translations into a single (or a few) addresses, which increases the effectiveness of the TLB 126.

Some embodiments of the MMU 122 leverage the popularity metadata to support other operations. For example, the MMU 122 can prefetch address translations associated with memory access requests based on the information representing the popularities of the entries.

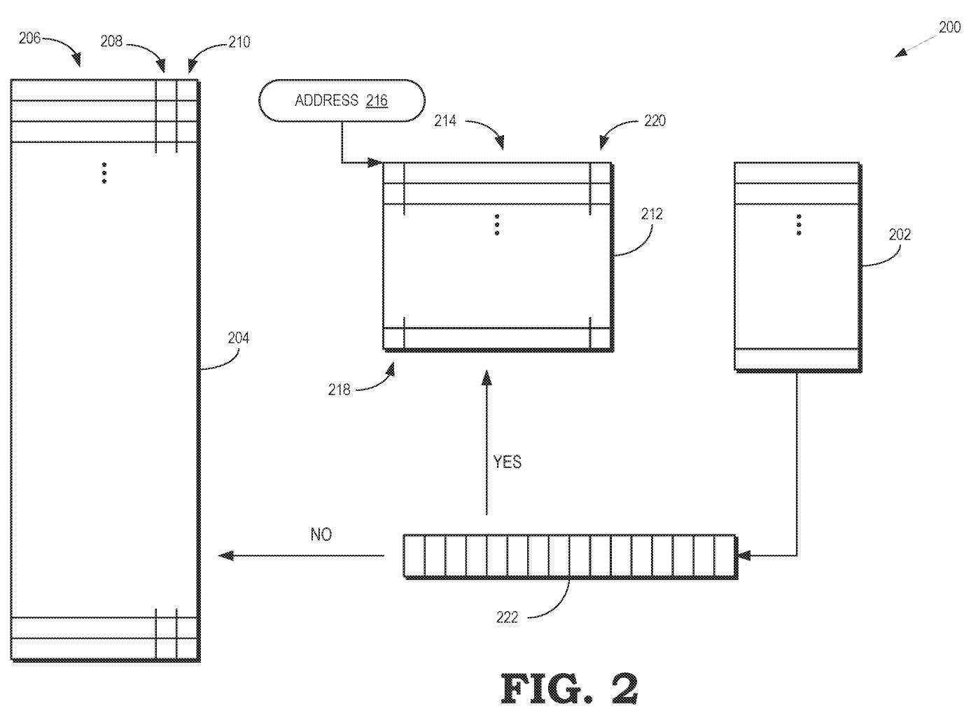

FIG. 2 illustrates a system 200 that selectively routes memory access requests to a primary table or a hot table based on the popularity of the requested entries, according to some embodiments. The system 200 is implemented in some embodiments of the processing system 100 shown in FIG. 1. In the illustrated embodiment, the system 200 receives a batch 202 of indices associated with memory access requests. The indices are used to generate the virtual memory addresses of pages in a memory that include the information requested in the corresponding memory access request. For example, if the memory access request is represented as A[index], then the virtual address of the memory location is given by index*element_size + base_address, where element_size is the size of elements in the memory (such as pages) and the base_address indicates a reference address for the set of virtual addresses that are allocated to the process making the memory access request.

The system 200 also includes a table 204 of entries 206 that are allocated to store information that is accessed by a process associated with the table 204. In the illustrated embodiment, the table 204 represents an embedding table used by a recommendation model such as DLRM. Entries 206 in the embedding table are configured to store information representing vector embeddings of data generated and accessed by the recommendation model. The table 204 is also configured to store metadata (or be associated with stored metadata) for each of the entries 206. In the illustrated embodiment, the metadata includes a subset bits 208 configured to store error correction codes (ECC) and a subset of bits 210 that are configured to store other metadata associated with the entries 206. However, the subset of bits 210 is not utilized in some embodiments and can therefore be used to store popularity metadata (or other information representing popularities) for the entries 206, as discussed herein. For example, in some cases, each embedding entry 206 spans 4 DRAM atoms (256B) within a DRAM row. The 256B of data in the entry 206 is associated with 32B of metadata out of which 16B is used for ECC bits 208. The remaining 16B in the unused subset of bits 210 is therefore available and can be configured to store information representing popularities such as popularity metadata.

Copies of a subset of the entries 206 that have relatively high values of popularity, as indicated by values of the bits 210, are copied into the entries 214 of a second, smaller table 212, which is referred to herein as a “hot” table.” As discussed herein, the values of the bits 210 are modified or incremented in response to memory access requests to the corresponding entry 206 so that higher values of the bits 210 indicate higher popularity. In the illustrated embodiment, the hot table 212 is stored in a single page that is located at a virtual address 216. However, in some embodiments, the hot table 212 is stored in multiple pages that are addressed using multiple virtual addresses. The individual entries 214 are indicated by a corresponding value or index 218 such as a hashed value of the virtual memory address included in the corresponding entry 206 in the table 204. In some embodiments, the entries 214 are also associated with verification information 220 such as another hashed value of the virtual memory address. The system 200 can therefore confirm that it has accessed the correct entry 214 by hashing the virtual memory address generated from the index in the memory access request and comparing the hashed value to the verification information 220.

A filter 222 is used to selectively route memory access requests to the table 204 or the hot table 212 based on whether a copy of the entry 206 indicated in the memory access request is likely to be in the hot table 212 due to the entry 206 having a high popularity. Some embodiments of the filter 222 are implemented as a Bloom filter that receives indices from the batch 202. The Bloom filter 222 is configured to determine whether the entry 206 associated with the index is likely or probably in the hot table 212 or definitely not in the hot table 212. In response to the Bloom filter 222 determining that the entry 206 is definitely not in the hot table 212, the memory access request is routed to the table 204. In response to the Bloom filter 222 determining that the entry is probably in the hot table 212, the memory access request is routed to the hot table 212. If the memory access request misses in the hot table 212, the memory access request is routed back to the table 204.

The hot table 212 is much smaller than the table 204. As discussed herein, some embodiments of the hot table 212 are stored on a single page, or perhaps a few pages, whereas the table 204 can require hundreds or thousands of memory pages (or more) to store all the entries 206 in the table 204. Thus, consolidating popular entries into the hot table 212 causes the memory access requests for the popular entries 214 to be addressed to a single address 216 (or perhaps a few addresses). The popular entries 214 are likely to be frequently accessed so that requests for address translations of the address 216 (or the few virtual addresses used for the hot table 212) are frequently conveyed to an MMU such as the MMU 122 shown in FIG. 1. The memory access requests for the popular entries 214 are therefore likely to hit in the one or more TLBs in the MMU (such as the TLB 126 shown in FIG. 1).

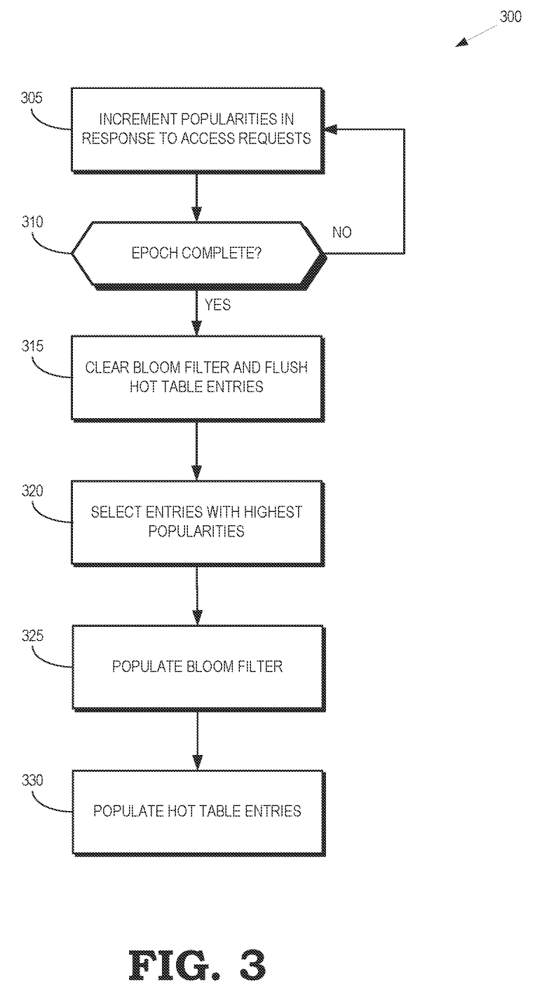

FIG. 3 illustrates a method 300 of managing a hot table that stores or caches copies of popular entries from a larger table, according to some embodiments. The method 300 is implemented in some embodiments of the processing system 100 shown in FIG. 1 and the system 200 shown in FIG. 2.

At block 305, a processing unit (such as the CPU 118 or the MMU 122 shown in FIG. 1) increments popularity metadata associated with entries in a table (such as the table 204 shown in FIG. 2) in response to memory access requests for the corresponding entries. The processing unit continues monitoring memory access requests and incrementing the popularity metadata until the end of an epoch.

At decision block 310, the processing unit determines whether a current epoch has completed. The duration of an epoch can be determined based on periodic time intervals, at predetermined time intervals, in response to events, or other techniques for determining the time interval that represents an epoch. Epochs may last a few hours or a few days or longer. If the processing unit determines that the epoch has completed, the method 300 flows to block 315. Otherwise, the method 300 flows back to block 305 and the processing unit continues to monitor memory access requests and increment the popularity metadata.

At block 315, in response to determining that the hot table is to be updated, the Bloom filter is cleared so that the current entries are removed. The current entries in the hot table are flushed. In some embodiments, clearing the Bloom filter and flushing the hot table entries are performed concurrently.

At block 320, entries in the table with the highest priorities are selected by the processing unit. For example, the processing unit can sort the entries in the table based on their popularity and then select a predetermined number of the entries having the highest popularity. The predetermined number is determined by the size of the hot table so that the selected entries fill the hot table.

At block 325, the Bloom filter is populated with information representing the entries that have been selected to be copied into the hot table. In some embodiments, the Bloom filter is populated with hashed values of the virtual memory addresses of the entries that have been selected to be copied into the hot table.

At block 330, the hot table entries are populated with the selected popular entries. In some embodiments, populating the hot table entries includes generating an index for each entry by hashing the virtual memory address of the entry with the first hashing function and generating verification information for each entry by hashing the virtual memory address of the entry with a second hashing function that can be different than the first hashing function.

Although the processes of blocks 315, 320, 325, 330are depicted as occurring sequentially in the embodiment shown in FIG. 3, the illustrated order is not required for the method 300. Some embodiments of the method 300 perform some or all the processes of blocks 315, 320, 325, 330 in other orders, in parallel, or concurrently.

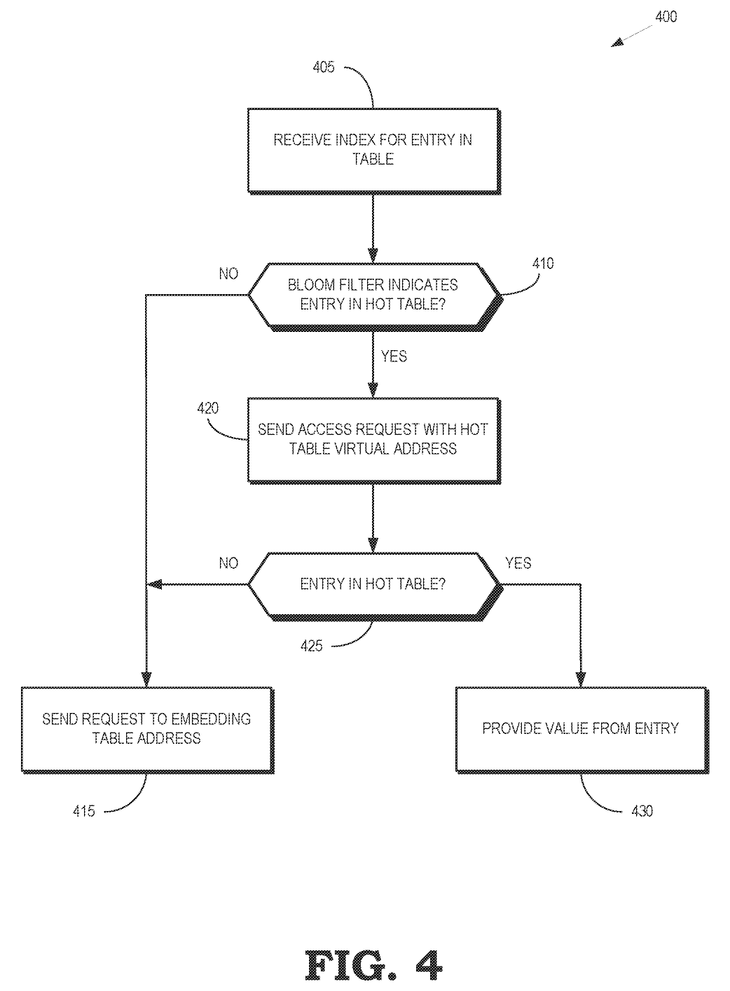

FIG. 4 illustrates a method 400 of selectively routing memory access requests to a table or a hot table that includes a subset of popular entries in the table, according to some embodiments. The method 400 is implemented in some embodiments of the processing system 100 shown in FIG. 1 and the system 200 shown in FIG. 2.

At block 405, a processing unit (such as the CPU 118 or the MMU 122 shown in FIG. 1) receives an index of an entry in the table, which can be an embedding table for a recommendation model or DLRM. The index is received in a memory access request for entry in the table.

At block 410, the index is passed to a filter that determines whether the index refers to an entry that is likely to be found in the hot table. Some embodiments of the filter are implemented as a Bloom filter that determines whether the entry is possibly in the hot table or definitely not in the hot table. If the Bloom filter indicates that the entry is definitely not in the hot table, the method flows to block 415. If the Bloom filter indicates that the entry is possibly in the hot table, the method 400 flows to the block 420.

At block 415, the memory access request is sent to the table because the entry is not in the hot table.

At block 420, the memory access request is sent to the hot table using a virtual address that indicates a page used to store the hot table.

At decision block 425, the processing unit determines whether the entry is in the hot table. The processing unit can determine that an entry is in the hot table by comparing a hash of a virtual memory address derived from the index in the access request to a hash value that is used as an index into the hot table, as discussed herein. If the two values match, there is a high probability that the hot table includes the entry. In some embodiments, the processing unit also verifies that the entry indicated by the hash of the virtual memory address is correct comparing another hash of the virtual memory address (or index) to verification information stored in the hot table, as discussed herein. If not, the method 400 flows back to the block 415 and the memory access request is sent to the table. If the entry is found in the hot table, the method 400 flows to the block 430.

At block 430, a value stored in the entry of the hot table is provided in response to the memory access request. In some embodiments, the value is read from the hot table using an address translation provided by an associated TLB, as discussed herein.

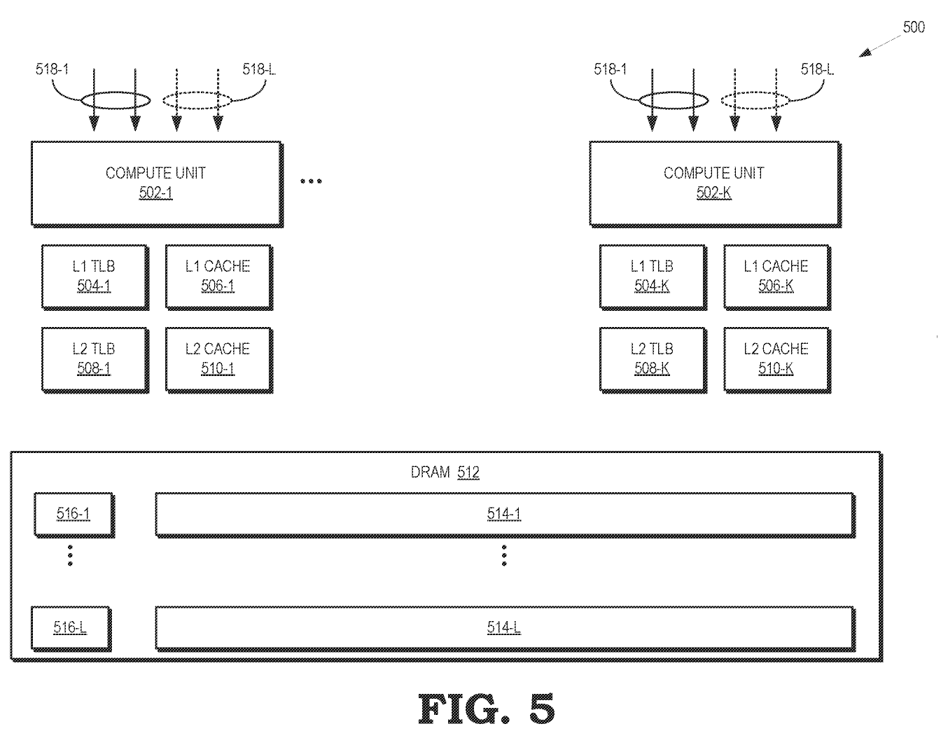

FIG. 5 illustrates a processing system 500 that is implemented with circuitry for multiple compute units 502-1..502-K, according to some embodiments. The processing system 500 is used to implement some embodiments of the processing system 100 shown in FIG. 1 and the system 200 shown in FIG. 2. Although two compute units 502 are shown in FIG. 5, more or fewer compute units 502 are implemented in some embodiments of the processing system 500. The compute units 502 include or are associated with TLBs and caches for accelerating access to frequently used address translations and memory locations, respectively. In the illustrated embodiment, the compute units 502 include level 1 (L1) TLBs 504-1..504-K and L1 caches 506-1..506-K, as well as level 2 (L2) TLBs 508-1..508-K and L2 caches 510-1..510-K, although more or fewer caches and levels of cache hierarchy are implemented in other embodiments.

The processing system 500 includes memory circuitry such as a DRAM 512. In the illustrated embodiment, the DRAM 512 stores multiple partitions 514-1..514-L of a table such as the table 204 shown in FIG. 2. The partitions 514 are associated with corresponding hot tables 516-1..516-L that are configured to store copies of the most popular entries from the corresponding partitions 514. Thus, the hot table 516-1 stores copies of popular entries from the partition 514-1 and the hot table 516-L stores copies of popular entries from the partition 514-L. Some embodiments of the hot tables 516 are managed and used according to the method 300 shown in FIG. 3 and the method 400 shown in 4, respectively.

The compute units 502 are configured to operate on corresponding partitions 514 and bypass operation of the partitions 514. Thus, threads running on different ones of the compute units 502 are responsible for updating values in different partitions 514 of the table. For example, the compute unit 502-1 executes threads 518-1 that include memory access requests for entries in the partition 514-1, and bypasses execution of threads 518-L that include memory access requests for entries in other partitions including the partition 514-L. The compute unit 502-L executes threads 518-L that include memory access request for entries in the partition 514-L, and bypasses execution of threads 518-1 that include memory access requests for entries in other partitions including the partition 514-1. The number (K) of compute units 502 can be the same or different than the number (L) of partitions 514 of the table.

Some embodiments of the processing system 500 are configured to dynamically allocate the compute units 502 to different partitions 514 of the table. For example, embedding bags operations can be performed concurrently or in parallel over multiple embedding tables or partitions of the embedding tables such as the partitions 514. The threads 518 are assigned to operate on selected partitions 514 of the embedding tables. If some threads 518 access the hot table 516 of an embedding table partition 514 more often than other threads 518, the mapping of the threads 518 to the compute units 502 is modified so that the average distribution of accesses over the different tables remains consistent. For example, if the threads 518-1 are accessing the hot table 516-1 more often than the threads 518-K are accessing the hot table 516-K, some or all the threads 516-1 can be reallocated or load balanced from the compute unit 502-1 to the compute unit 502-K. Thus, the load is balanced across compute units 502 (or clusters of compute units) to average out the TLB pressure resulting from accesses to the hot table 516.

Resources can also be allocated based on the information representing the popularity of entries in the table or the partitions 514 of the table. For example, if the information representing the popularities (or a statistical combination of the popularities) indicates that the popularity of entries in the hot table 516-1 is higher (at least in a statistical sense) than the popularity of entries in the hot table 516-L, additional compute units 502 or more resources of the compute units 502 can be allocated to the partition 514-1 and fewer resources allocated to the partition 514-L. In some embodiments, the caches 506, 510 associated with the compute units 502 (or clusters thereof), as well as the corresponding TLBs 504, 508, can be allocated to hold entries only from the hot tables 516 associated with the embedding table(s) associated with threads executing on the compute units 502 (or clusters thereof).

In some embodiments, certain aspects of the techniques described above are implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

Note that not all the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the embodiments disclosed above may be altered or modified and all such variations are considered within the scope of the disclosed subject matter. Accordingly, the protection sought herein is as set forth in the claims below.

What is claimed is:

1. An apparatus comprising:
at least one processor configured to:
modify, in a first table, a subset of bits representing popularities of entries stored in the first table in response to access requests to the entries, wherein the popularities represent frequencies or likelihoods that corresponding ones of the entries were previously accessed; and
copy a subset of the entries from the first table to a second table based on their popularities.

2. The apparatus of claim 1, wherein the entries are configured to store information representing vector embeddings of data produced by a recommendation model.

3. The apparatus of claim 1, further comprising:
at least one memory comprising the first table, the second table, and a plurality of bits configured to store metadata associated with the entries, the plurality of bits comprising the subset of bits, and wherein a second subset of the plurality of bits is configured to store error correction codes for the entries.

4. The apparatus of claim 1, further comprising:
a filter configured to selectively route data requests to the first table or the second table.

5. The apparatus of claim 4, wherein the filter is a Bloom filter that receives indices in the data requests and determines, based on the indices, whether a requested entry is possibly stored in the second table or definitely not stored in the second table.

6. The apparatus of claim 5, wherein a data request of the data requests is routed to the second table in response to the Bloom filter determining that the requested entry is possibly stored in the second table, and wherein the data request is routed to the first table in response to the Bloom filter determining that the requested entry is definitely not stored in the second table.

7. The apparatus of claim 1, wherein the at least one processor is configured to:
select the subset of entries of the first table periodically, at predetermined time intervals,or in response to an event;
flush the entries from the second table; and
copy the subset of entries of the first table to the second table in response to selecting the subset of entries.

8. The apparatus of claim 1, further comprising a plurality of second tables configured to store copies of different subsets of the entries based on their popularities.

9. The apparatus of claim 8, wherein the at least one processor comprises a plurality of compute units associated with the plurality of second tables, and wherein a mapping of threads to the plurality of compute units is determined based on a distribution of access requests that are routed to the first table and the plurality of second tables.

10. The apparatus of claim 9, wherein the first table is partitioned such that threads running on different ones of the plurality of compute units are responsible for updating values in different partitions of the first table.

11. A method comprising:
storing, in entries of a first table, information representing vector embeddings generated by a model;
modifying a subset of bits representing popularities of the entries in response to access requests to the entries; and
copying a subset of the entries from the first table to a second table based on the popularities.

12. The method of claim 11, further comprising:
selectively routing a data request to the first table or the second table based on whether an entry indicated in the data request is possibly stored in the second table or definitely not stored in the second table.

13. The method of claim 12, wherein selectively routing the data request comprises routing the data request to the second table in response to determining that the entry indicated in the data request is possibly stored in the second table.

14. The method of claim 12, wherein selectively routing the data request comprises routing the data request to the first table in response to determining that the entry indicated in the data request is definitely not stored in the second table.

15. The method of claim 11, further comprising at least one of:
prefetching an address translation associated with the access requests based on thesubset of bits representing the popularities of the entries;
load balancing between compute units based on the information representing the popularities of the entries; or allocating resources based on the information representing the popularities of the entries.

16. An apparatus comprising:
a first table comprising vector embeddings of data and a subset of bits representing popularities of the vector embeddings, wherein the popularities represent likelihoods that corresponding ones of the vector embeddings will be accessed in a subsequent memory access request;
at least one second table configured to store copies of a first subset of the vector embeddings based on the popularities of the vector embeddings in the first subset;and
at least one processor configured to modify the copies of the first subset and thesubset of bits representing the popularities of the vector embeddings in response to access requests to the first table.

17. The apparatus of claim 16, further comprising:
a filter configured to selectively route a data request to the first table or the at least one second table based on whether an entry indicated in the data request is possibly stored in the at least one second table or definitely not stored in the at least one second table.

18. The apparatus of claim 17, wherein the filter is configured to selectively route the data request to the at least one second table in response to determining that the entry indicated in the data request is possibly stored in the second table and to selectively route the data request to the first table in response to determining that the entry indicated in the data request is definitely not stored in the second table.

19. The apparatus of claim 18, further comprising:
a recommendation model configured to generate the vector embeddings of the data and to perform an embedding bags operation that reads a second subset of the vector embeddings and collapse the second subset to a single value.

20. The apparatus of claim 19, wherein at least one of the vector embeddings in the second subset is stored in the second table.
